(19) United States
(12) Patent Application Publication
(10) Pub. No.: US 2015/0309673 A1
(43) Pub. Date: Oct. 29, 2015

(54) MEDIA COLLECTION SYSTEM AND METHOD

(71) Applicant: Stephen L. Brandley, Mendon, UT (US)

(72) Inventor: Stephen L. Brandley, Mendon, UT (US)

(21) Appl. No.: 14/679,582

(22) Filed: Apr. 6, 2015

Related U.S. Application Data
(60) Provisional application No. 61/975,188, filed on Apr. 4, 2014.

(51) Int. Cl. G06F 3/0482; G06F 3/0484; G06F 17/30; G06F 3/0486

(52) U.S. Cl. CPC G06F 3/0482; G06F 3/0486; G06F 3/04842; G06F 17/30126

(57) ABSTRACT

A media collection system and method including a user interface module operating through a user interface device that allows a user to add media information to a structured media collection. The user interface module includes a real-time recording module that allows a user to record media information to a media file in real-time. The real-time recording module includes a countdown synchronization module, a prompt module, and a recording control module. The user interface module includes an organization module that allows a user to associate media files within a hierarchical structure. The system includes a media structure module that enforces and presents stored media files according to their association within the hierarchical structure.

### CROSS-REFERENCE TO RELATED APPLICATIONS

This invention claims priority, under 35 U.S.C. §120, to the U.S. Provisional Patent Application No. 61/975,188 to Stephen L. Brandley filed on Apr. 4, 2014, which is incorporated by reference herein.

### BACKGROUND OF THE INVENTION

1. Field of the Invention

The present invention relates to computing systems and methods, specifically to media collection and organization systems and methods over a computerized network.

2. Description of the Related Art

An outline, also called a hierarchical outline, is a list arranged to show hierarchical relationships and is a type of tree structure. It is used to present the main points or topics of a given subject, often used as a rough draft or summary of the content of a document. Preparation of an outline is an intermediate step in the process of writing a scholarly research paper, literature review, thesis or dissertation. A special kind of outline (integrated outline) incorporates scholarly sources into the outline before the writing begins.

Outline Software is a note-taking application, available on iOS and OS X platforms. The distinguishing features of Outline are design, hierarchy, free placement of notes as in paper notebook, support of various types of content (text, images, inks, tags, web-content, etc.), synchronization options and Microsoft compatibility.

Outline hierarchy resembles that of a real notebook: there are notebooks for general subjects, section tabs for specific topics and pages for actual notes. For more complex notebook structures additional section groups can be created within a notebook. There is no limitation on the number of notebooks, section groups, section tabs and pages.

Some improvements have been made in the field. Examples of references related to the present invention are described below in their own words, and the supporting teachings of each reference are incorporated by reference herein:

U.S. Pat. No. 5,875,448, issued to Boys et al., discloses an audio editor operates with files capable of storing text and voice data in separate regions, and provides functions for entering data as voice data, and also for fully editing the entered voice data. Files can be uploaded from the Audio Editor to a PC application for converting the file entirely to text, providing a system wherein all variable entry and editing can be done verbally, and conversion to text left as a final chore. In an alternative embodiment the Audio Editor is implemented as a PC application wherein a user can enter and fully edit variable input as voice, and then communicate the resulting file to another for final conversion. In yet another embodiment the Audio Editor is implemented as additional functionality to a high-end word processor application. In further embodiments computerized natural data editors are provided for reviewing and editing natural data streams of all sorts, such as video streams, musical works, and the like.

U.S. Pat. No. 7,171,113, issued to Parulski et al., discloses a digital camera for capturing images and for adding personal image metadata labels to the captured images, including an image sensor for capturing a plurality of images; an analog-to-digital converter for digitizing the plurality of captured images, from the image sensor, to produce a plurality of captured digital images. Also, included in the digital camera is a memory location for storing the plurality of captured digital images; a display coupled to the memory location for displaying at least one of the plurality of captured digital images. The digital camera has a user control for selecting a personal image metadata label which corresponds to an emotional or aesthetic category as judged by a user; and a processor responsive to the user control for associating the personal image metadata label with the at least one of the plurality of displayed captured digital image.

U.S. Pat. No. 8,219,502, issued to Gold et al., discloses an automated interview systems and methods are disclosed. An exemplary method comprises selectively presenting interview questions based on user input to at least one interviewee identified by a user, and receiving answers from the at least one interviewee in response to presenting the interview questions. The method further comprises compiling the interview questions and received answers as a recorded interview to assist the user to build online references for the user's products or services.

U.S. Patent Application Publication No.: 2011/0320495, by Levy-Yurista et al., relates to automatic logging of people's lives by combining a geo-location tracking system, a data storage service and sharing services. In particular, a method and a system for location reporting using geo-location tracking devices, such as mobile communication devices, social networks and data storage and manipulation services. The data points collected from geo-location tracking receivers are then associated with information collected from various external information sources provided by the user and presented as points, milestones, or periods along the user's path, past, present and future.

The inventions heretofore known suffer from a number of disadvantages which include being difficult to use, being difficult for people who are not tech savvy to use, failing to allow listeners to skip to important regions of an audio, failing to mark important portions of media, not being customizable, being rigid in structure, not being versatile, applying to a limited scope of industries/niches, being inconvenient, failing to preserve audio information for posterity, limiting the scope of those who can publish, failing to serve those who are crippled/illiterate or otherwise lacking in ability

What is needed is a media collection system that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available media collection systems and methods. Accordingly, the present invention has been developed to provide an easy and fast media collection system and method.

According to one embodiment of the invention, there is a media collection system that may include a user interface module that may be operating through a user interface device that may allow a user to add media information to a structured media collection. The user interface module may include a real-time recording module that may allow a user to record media information to a media file in real-time. The real-time recording module may include a countdown synchronization module that may display a real-time countdown to initialization of a recording. The real-time recording module may include a prompt module that may display suggested recording topics. The real-time recording module may include a recording control module that may allow a user to control the initialization, stop, and file location of recording.

The user interface module may include an organization module that may allow a user to associate media files within a hierarchical structure; wherein the organization module may be graphical, drag and drop, connectivity. The user interface module may include a place finder module that may allow a user to back-up, seconds and play, then record with countdown. The user interface module may include a delay module that may allow a user to delay the initialization of a recording. The user interface module may include an automated marking module that may allow a user to automatically mark parts of a recording from a trigger. The user interface module may include a voice recognition module that may allow voice recognition for a user during recording of media information.

The media collection system may include a media structure module that may enforce and present stored media files according to their association within the hierarchical structure. The media collection module may include a template module that may provide preset hierarchical structure and prompts. The media collection module may include a user account module that may allow different permissions for users; wherein other users may add media content but cannot delete media content. The media collection module may include a publication module that may allow a user to publish a structured media collection over a computerized network.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a media collection system, according to one embodiment of the invention;

FIG. 2 is a module diagram of a media collection system, according to one embodiment of the invention;

FIG. 3 is a module diagram of a user interface module, according to one embodiment of the invention;

FIG. 4 is an exemplary screenshot of a media collection system, according to one embodiment of the invention;

FIG. 5 is an exemplary screenshot of a media collection system, according to one embodiment of the invention;

FIG. 6 is an exemplary screenshot of a media collection system, according to one embodiment of the invention;

FIG. 7 is an exemplary screenshot of a media collection system, according to one embodiment of the invention;

FIG. 8 is an exemplary screenshot of a media collection system, according to one embodiment of the invention;

FIG. 9 is an exemplary screenshot of a media collection system, according to one embodiment of the invention;

FIG. 10 is an exemplary screenshot of a media collection system, according to one embodiment of the invention; and

FIG. 11 is an exemplary screenshot of a media collection system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module of programmable or executable code may, for instance, comprise one or more physical or logical blocks of computer instructions which may, for instance, be organized as an object, procedure, or function.

Nevertheless, the executables of an identified module need not be physically located together, but may comprise disparate instructions stored in different locations which, when joined logically together, comprise the module and achieve the stated purpose for the module. Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Andriod, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

The present invention may be described herein in terms of functional block components, functions, options, screen shots, user interactions, optional selections, various processing steps, features, user interfaces, and the like. Each of such described herein may be one or more modules in exemplary embodiments of the invention even if not expressly named herein as being a module. It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, the term “network” includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

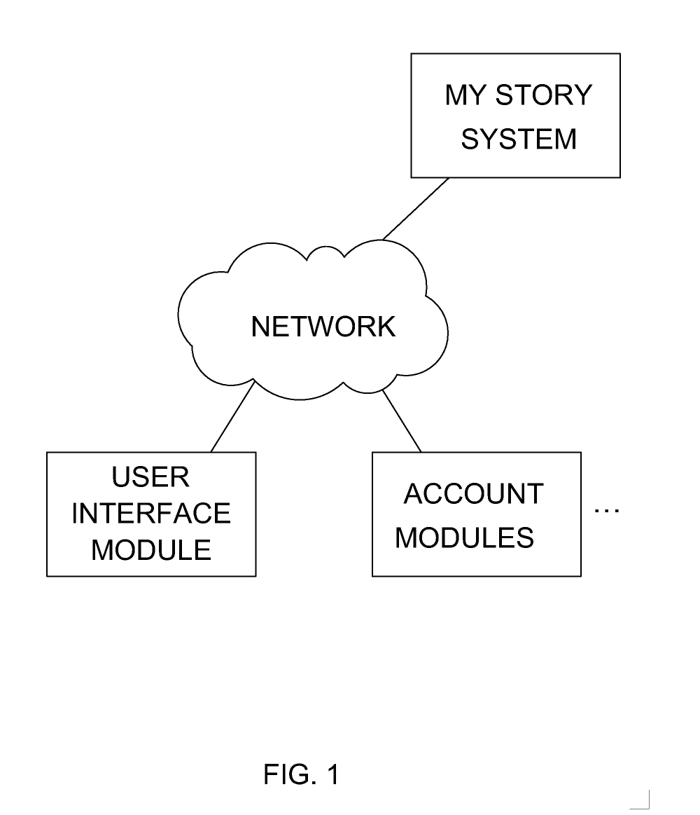

FIG. 1 is a network diagram of a Media collection system, according to one embodiment of the invention. There is shown a Media collection system in communication with a plurality of user interface modules over a computerized network. As used herein a “Media collection system” means a system of organizing and/or interfacing with media. Similarly, a “Media collection method” means a method of organizing and/or interfacing with media.

The illustrated media collection system or My Story system is configured to provide an effective and/or efficient method of creating a personal timeline including voice recordings, images, videos, and/or etc. for a plurality of users over a computerized network. There may be one or more modules that facilitate the collection of media into an indexed group of associated materials. Associations may include orderings of media (e.g. automatic display of media file A comes before automatic display of media file B), insertions (media file A is inserted into media file B at point in time/location C such that, while presenting media file B, the system will automatically present media file A or an option to experience media file A at a particular time/location), and the like and combinations thereof. Media may include but is not limited to digital audio recordings (e.g. MP3, WAV, AIFF, etc. files), digital video files (e.g. MP4, AVI, MPEG, and etc.), digital images (e.g. FITS, TIFF, JPEG, GIF, and etc.), structured information display files (e.g. XML, DOC, TXT, XLSX, PDF, and etc.), digital access to information (function calls, hyperlinks, driver calls to operate linked analog/digital devices such as but not limited to tape players, record players, DVD players, etc.), and the like and combinations thereof. Media may be stored in non-transitory forms on data storage devices, such as but not limited to ROM, RAM, hard drives, flash drives, tapes, and etc. Associations may be formed by automatically generating function calls, pointers, GoTo/While-style operations, hyperlinks, software/hardware triggers and the like and combinations thereof. There may be a user interface module that facilitates in the collection of media and forming desired associations therebetween.

Such a collection and such associations may be stored/managed/controlled/protected by a media collection system and the user interface that facilitates the same may be an extension thereof. Such a user interface module may include one or more tools for recording/editing media (microphone, video camera, camera, text entry tool, image editing tool, video editing tool, audio editing tool, etc.), one or more tools for transferring data (e.g. network card, bus, network drivers, upload management tool, encryption/decryption tool, etc.), and/or tools for editing associations between/amongst media (e.g. programming suite, multimedia editing tool, etc.).

The illustrated system manages categorization of video or voice recordings and/or associations of media files with portions of the same, and creates a format that is easy to retrieve by category and subcategory. Such a system may include an indexing and/or table-of-contents style module that graphically displays one or more types of association amongst a group of media associated together. Associations may be graphically editable through such a module, wherein a user may automatically change one or more associations between media by dragging a graphical representation of a media to a different region of a screen that then automatically creates and/or destroys one or more associations amongst the affected media. As a non-limiting example, a user may drag a graphical representation of an audio recording from a category entitled “Stories” or (“Adult years”) and drop it into a location on their screen associated with a category entitled “My Wedding,” thus associating the media with the “My Wedding” category. It may be that during the drag and drop process, there is a drop destination region that automatically severs one or more previous associations and another region that does not sever previous associations.

Wherein media is associated by categories, the user may, through the user interface module, be able to edit category names, orders of categories, sub-category relationships amongst categories, and the like and combinations thereof. Further, the illustrated system may allow a user to make additions to each category and subcategory and changes thereto through a user interface module. Such changes may be automatically propagated through memory such that changes to associations are recorded, graphical displays of the same are automatically updated and presentations of the same are done according to the new associations.

The illustrated system is able to take a voice recording section and then associate that with another category or sections and/or subcategory and/or subsections. Accordingly, a particular portion of an audio recording may be associated with one category or subcategory while portions thereof may be associated with others. As a non-limiting example, a portion of an audio recording describing a wedding may be associated with a “My Wedding” category in a set of categories outlining timeline of a person's life, while a subsegment of that recording may be associated with a “Times I got in trouble” category or sub-category that may be within a set of categories relating to topical subject matter. Thus, the same story may be accessible through multiple access points in a presentation, index and/or table of contents that may be presented to a consumer of the media, such as but not limited to the posterity of a user who recorded and/or constructed the collection of associated media within the system.

The illustrated system is able to add videos, photos and documents tied to the audio recording blocks. Accordingly, a consumer of an associated media collection may be able to access relevant media associated with audio that they are experiencing. As a non-limiting example, there may be an audio block describing a wedding that has wedding photos, a scanned marriage certificate, a video of a ring ceremony, and/or a scrolling listing of vows/commentary that is automatically presented to the consumer of the media and/or optional access to the same is automatically presented to the consumer of the media at specified times and/or time regions throughout the experience of the same.

Media files may be categorized into sections and subsections as well for future reference or use. By use of a user interface, a user creating a collection of associated media may create categories/subcategories, and/or may utilize the same from a template provided by the system/interface and/or may be enabled to edit the same, including but not limited to changing category/subcategory names, the order in which they are presented, their dependency status, and the like and combinations thereof. When uploading and/or recording media, the user may be able to select one or more categories with which to associate the media and/or may be enabled, by the user interface in cooperation with the system, to designate portions thereof that may be associated with particular categories/subcategories.

The illustrated system includes a recording process that is very simple and provides detailed instructions and extra explanations, walk-throughs, and templates so that novice users may be much more comfortable with using the system and the process. This enables those who are not tech savvy to use the system and feel more confident in the same. Such a process may include one or more of the following steps: providing automatic visual/audible explanations of upcoming steps and/or statuses of the recording process, equipment, etc.; automatically delaying one or more steps; automatically providing a visual/audible countdown before beginning a recording step such as but not limited to displaying a countdown on a graphical user interface before actually recording, thus providing the user with a warning and clear indication of when they should start talking into the microphone; automatically marking portions of a recording based on one or more triggers, such as but not limited to the system recognizing the presence of a particular word or phrase in the recording; automatically displaying a category and/or subcategory with which the recording is to be automatically associated; and the like and combinations thereof.

The illustrated system may insert an audio recording into an existing and already recorded audio stream and/or otherwise edit audio streams. It may be that media that are linked/registered to audio blocks stay linked to those blocks even if more audio blocks are inserted. Accordingly, a user may be able to augment previous recordings or the recordings of others. Accordingly, a user who is recording and/or reviewing a previous recording, may find a place where more details are needed and then hit record to insert more audio at the point they selected. Indeed, multiple users may be able to contribute to a collection of media, such as but not limited to associating their own audio recordings that may represent their version of a particular story/recollection and associating the same and/or inserting the same into one previously done by another so that a consumer of the collection of media may have access to multiple viewpoints and/or sets of related information.

The system may also include tools for generating and enforcing rules about what associations and/or editing processes can or cannot apply to particular media and/or to particular media collections, such as but not limited to restricting what media can be associated with what media, which users can make/break particular associations and/or types of associations, limits to the number of associations that one media or set of media may have with another, and the like and combinations thereof. There may be different rights and privileges associated with particular user accounts and it may be that the original creator of a particular media file may have additional/expanded/different rights to make/break associations and/or add/remove/edit media than other users which may be additional contributors and/or consumers of the media. There may be limitations on the original creator in the same that may restrict an original creator and such restrictions may automatically change when a collection of media is published through the system.

The illustrated system may operate over an external network (e.g. the internet) and/or on an electronic device that may be without access to an external computerized network, such as but not limited to operating over a personal computing device such as but not limited to a desktop computer, a tablet, and/or a smartphone. Accordingly, the system may be wholly functional within a single electronic device and the network may merely be a bus (or the equivalent) that functionally coupled the interface module to the system.

The illustrated system may trigger categorization by voice prompts that may be associated with buttons on phones or other computing devices. The system may include a voice recognition module configured to process input audio and may associate one or more recognized audio blocks as commands and forward such commands to a control module for processing into instruction sets for the system.

The illustrated system publishes and distributes recordings to share with family and friends. There may be a publishing module that may include information and/or scripts regarding distribution of media collections and/or distribution of access/accounts for accessing the same. There may be a packaging module as part of the publishing module that may convert a collection of media package into one or more transmission protocols, may convert between file types within a collection of media packages, may convert among display formats (e.g. screen size, resolution, etc.).

The illustrated system is in communication with a plurality of user interface modules over a computerized network. The plurality of user interface modules may be included in a personal computing device such as but not limited to a smart phone or tablet. Interface modules may record and store information that may be uploaded to the system for categorization and editing.

In one non-limiting embodiment, there is a method including the steps of taking an audio stream and categorizing and subcategorizing portions thereof. Such a method may include the steps of: recording a first audio block marking in memory, the marking associated with a first audio block; recording a second audio block marking in memory, the marking associated with a second audio block; recording a category in memory; recording a sub-category in memory; recording an association of the subcategory with the category in memory; and/or providing a user interface configured to permit consumption of the first and second audio blocks.

In one non-limiting embodiment, there is a method including the step of providing enhanced support during a recording process. Such a method may include the steps of: providing an enhanced support module; through the enhanced support module providing automatic visual/audible explanations of upcoming steps and/or statuses of the recording process, equipment, etc.; automatically delaying one or more steps of a recording process; automatically providing a visual/audible countdown before beginning/completing/transitioning to a recording step such as but not limited to displaying a countdown on a graphical user interface before actually recording, thus providing the user with a warning and clear indication of when they should start talking into the microphone; automatically marking portions of a recording based on one or more triggers, such as but not limited to the system recognizing the presence of a particular word, phrase, or pause in the recording; automatically displaying a category and/or subcategory with which the recording is to be automatically associated; and/or the like and combinations thereof.

In one non-limiting embodiment, there is a method including the steps of associating media files with audio segments and categorizing and subcategorizing the same. Such a method may include the steps of: receiving a media file over a network; providing an upload manager module; recording an association between a media file and an audio segment; recording an association between a media file and a category or sub-category; automatically copying an association from an audio segment to a media file associated therewith in reaction to a trigger associated with creating an association between the media file and the audio segment; and the like and combinations thereof.

Advantageously, various embodiments of the invention provide a great array of benefits including but not limited to one or more of the following: being easy to use, being easy for people who are not tech savvy to use, allowing listeners to skip to important regions of an audio, marking important portions of media, being customizable, the ability to categorize and sub-categorize, having a flexible structure, being versatile, applying to a wide scope of industries/niches, being convenient, preserving audio information for posterity, broadening the scope of those who can publish, and/or better serving those who are crippled/illiterate or otherwise lacking in ability.

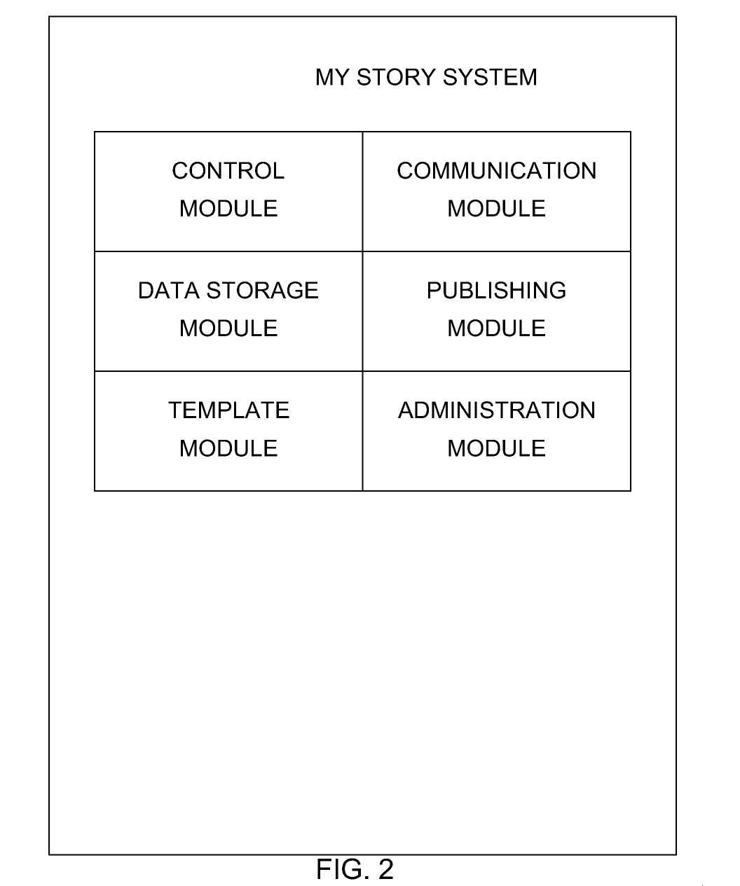

FIG. 2 is a module diagram of a Media collection system, according to one embodiment of the invention. There is shown a media collection system including a control module, a communication module, a data storage module, a publishing module, template module, and an administration module.

The illustrated media collection system or My Story system includes a control module functionally coupled to the modules and components of the Media collection system. The control module is configured to manage operational controls, standards, parameters, or settings of the Media collection system. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated media collection system includes a communication module in communication with the modules and components of the Media collection system. The communication module is configured to provide communication capabilities to the modules and components of the Media collection system. Such communication may be wireless, especially in regards to communications over a network, and/or may be wired and/or over a bus, such as may generally be found within a portable communication device. The communication module may also be configured to provide a secure method of communication over a computerized network. Non-limiting examples of a communication module may be but not limited to: a communication module described in U.S. Pat. No. 5,307,463, issued to Hyatt et al.; or a communication module described in U.S. Pat. No. 6,133,886, issued to Fariello et al. which are incorporated for their supporting herein.

The illustrated media collection system includes an administration module configured to provide administrative controls to an administrator of the Media collection system. The administration module is configured to set and edit parameters and settings for each of the modules and components of the Media collection system, including authorization to access the modules and components thereof. The administration module is configured to generate and regulate the use of each user interface module or user profile or account of the media collection system over a computerized network. Non-limiting examples of an administration module may be an administration module as described in U.S. Patent Publication No.: 2011/0125900, by Janssen et al.; or an administration module as described in U.S. Patent Publication No.: 2008/0091790, by Beck, which are incorporated for their supporting teachings herein.

The illustrated media collection system includes a data storage module in communication with the various modules and components of the Media collection system. The data storage module is to store data transferred through the modules and components of the media collection system. The data storage module is configured to securely store user, administration, and usage data along with authentication and authorization codes to access the Media collection system. The data storage module is configured to store data from the Media collection system, including data from the users of the system, data from authors of templates, data from third party viewers of the system, and data from the administrators of the system. Data storage modules may be databases or data files, and the memory storage device may be hard drives or tapes. A non-limiting example of a data base is Filemaker Pro 11, manufactured by Filemaker Inc., 5261 Patrick Henry Dr., Santa Clara, Calif., 95054. Non-limiting examples of a storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated media collection system includes a publishing module in communication with the modules and components of the system. The publishing module publishes user recordings or compilations over a computerized network. The publishing module also publishes templates used by other users of the system for examples or as a reference for other users of the system. The publishing module is configured to publish recordings or templates publically or privately to users over a computerized network. Non-limiting examples of a publishing module may be a system as described in U.S. Patent Publication No.: 2012/0310884; or a publishing module as described in U.S. Patent Publication No.: 2008/0228507, which are incorporated for their supporting teachings herein.

The illustrated media collection system includes a template module in communication with the modules and components of the system. The template module includes a library of templates selectable by a user for use in creating a recording or compilation of recordings in a timeline. The template module may store templates for public use or for private use over a computerized network. The template module includes examples of how to create a recording or compilation or recordings. Non-limiting examples of a template module may be a management system as described in U.S. Patent No Publication No.: 2010/0042503 by Farmer; or a management module as described in U.S. Patent Publication No.: 2011/0251888 by Faith et al., which are incorporated for their supporting teachings herein.

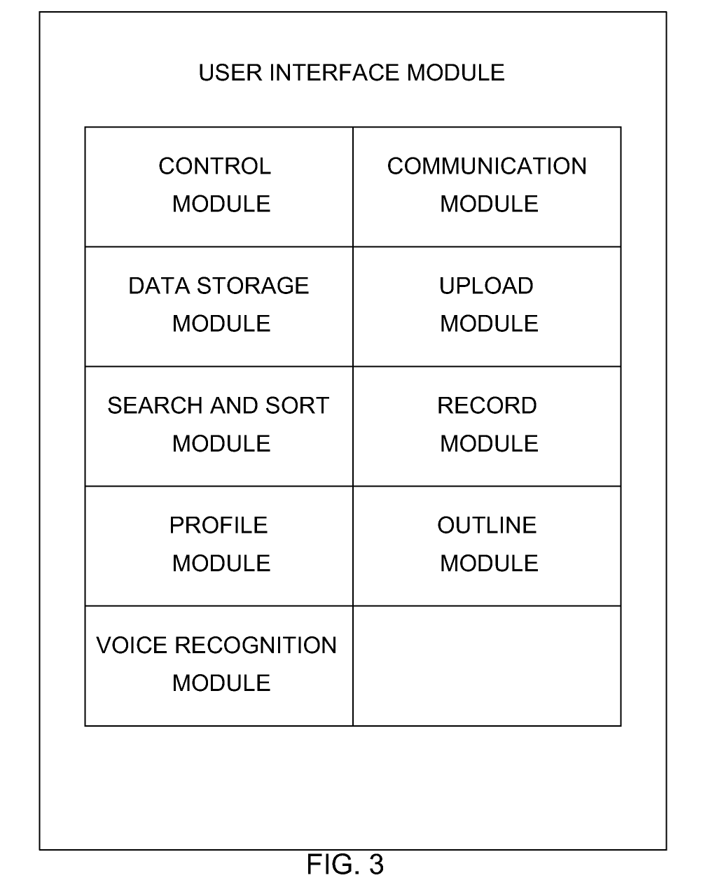

FIG. 3 is a module diagram of a user interface module, according to one embodiment of the invention. There is shown a user interface module including a control module, a communication module, a data storage module, an upload module, a search module, a record module, a sort module, an outline module, and a profile module.

The illustrated user interface module includes a control module functionally coupled to the modules and components of the user interface module and configured to provide operational controls to navigate the modules and components of the user interface module. The user interface module may be included in a personal computing device or a personal cell phone.

The illustrated user interface module includes a communication module in communication with the modules and components of the user interface module. The communication module is configured to provide communication capabilities to the modules and components of the user interface module. Such communication may be wireless, especially in regards to communications over a network, and/or may be wired and/or over a bus, such as may generally be found within a portable communication device. The communication module is also configured to provide a secure method of communication over a computerized network.

The illustrated user interface module includes a data storage module in communication with the various modules and components of the user interface module and is configured to store data transferred therethrough. The data storage module is configured to securely store user, author, and viewer account or profile data along with authentication and authorization codes to access the user interface module. The data storage module is configured to store data from the user interface module, including data from the users of the system, data from authors of templates, data from third party viewers of the system, and data from the recordings and usage of the system.

The illustrated user interface module includes an interface module or an adaptive graphical user interface module. The G.U.I. module is configured to provide individual user interface capabilities with the modules and components of the user interface module and the Media collection system over a computerized network. The interface module is configured to provide one or more interfaces for accessing the computerized system over a computerized network. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the computerized system, issue suggestions or recommendations, and receive data information therefrom. Such may be embodied in one or more user interfaces that permit browsing of the computerized system. Such may be embodied in one or more user interfaces that permit service personnel or administrators to make adjustments, changes, and otherwise provide personal profile or account updates to the computerized system. Such may be embodied in one or more user interfaces that permit review of data from the system, such as but not limited to template data, interactive recording data, user and usage data, management data, database usage, etc. Non-limiting examples of an interface module may be a HTML player, client server application, Java script application. A non-limiting example of an interface module is FlowPlayer 3.1, manufactured by FlowPlayer LTD, Hannuntie 8 D, ESPOO 02360, Helsinki, Finland. Non-limiting examples of a display/interface module may be a display/interface module as described in U.S. Pat. No. 6,272,562, issued to Scott et al.; a touch screen interface module as described in U.S. Pat. No. 5,884,202 and U.S. Pat. No. 6,094,609, issued to Arjomand, which are incorporated for their supporting teachings herein.

The illustrated user interface module includes a profile module in communication with the modules and components of the user interface module and is configured to manage and store personal user or author settings, preferences, and parameters for use with the Media collection system. The profile module is configured to store user template and database preferences and interests, based upon user input and also previous user history. Non-limiting examples of a profile module may be a user account including demographic information about a user as well as preference information about a user that is associated therewith. Such information may include preferred usage, objectives, and the like and combinations thereof. Such may be embodied in a database or other data structure/hierarchy such that the data associated with each user may be used by one or more modules described herein and/or may be altered and/or added to by one or more modules described herein.

The illustrated media collection system or My Story system includes a search and sort module in communication with the modules and components of the Media collection system. The search and sort module is in communication with a plurality of data sources including data stored on a personal computing device, a personal cell phone, or in the Media collection system over a computerized network. The search and sort module is configured to search the data sources for relevant images or recordings stored by the user. The search and sort module is configured to search and sort data based on characteristics, key terms, and parameters set by a user. The search and sort module is configured to search most relevant data sources that most frequently include the most relevant key terms used by the user, or the search and sort module is configured to search and sort by time or location. Non-limiting examples of a search and sort module may be a system as described in U.S. Pat. No. 8,406,912; or a system as described in U.S. Patent Publication No.: 2013/0006945, which are incorporated for their supporting teachings herein.

The illustrated user interface module includes a record module configured to record videos, voices, images, etc. to a personal computing device or a personal cell phone. The record module is configured to store time and location data of the recording or image. The record module is in communication with the data storage module, wherein the recording is automatically stored in the data storage module for future use or editing. Non-limiting examples of a record module may be a system as described in U.S. Patent Publication No.: 2012/0035919; or a system as described in U.S. Pat. No. 8,515,497, which are incorporated for their supporting teachings herein.

The illustrated user interface module includes an upload module in communication with the modules and components of the user interface module. The upload module is configured to upload user recordings or data to the Media collection system. The upload module is configured to format the user recordings or data to collaborate with the other recordings and data stored in the Media collection system. The upload module may be configured to convert recordings from one format to another for easier usage and editing. Non-limiting examples of an upload module may be a system as described in U.S. Patent Publication No.: 2012/0054760; or a system as described in U.S. Patent Publication No.: 2012/0036215, which are incorporated for their supporting teachings herein.

The illustrated user interface module includes an outline module in communication with the modules and components of the user interface module. The outline module is configured to provide an outline; wherein videos, voice recordings, and images may be included to create a timeline of events or recordings. The outline module may provide or create a template for the user to use throughout the process of creating the videos and recordings. Non-limiting examples of an outline module may be a system as described in U.S. Pat. No. 8,543,604; or a system as described in U.S. Pat. No. 8,645,383, which are incorporated for their supporting teachings herein.

The illustrated user interface module includes a voice recognition module in communication with the modules and components of the user interface module. The voice recognition module is configured to recognize a user's voice and record the voice in a recording block. The voice recognition module may be configured to associate the voice with a recording, image, or video. The voice recognition module may be configured to recognize the user's voice and complete commands or instructions to the user interface module and the module and components thereof. Non-limiting examples of a voice recognition module may be a voice recognition system as described in U.S. Patent Publication No.: 2003/0204403; or a voice recognition module as described in U.S. Pat. No. 8,595,008, which are incorporated for their supporting teachings herein.

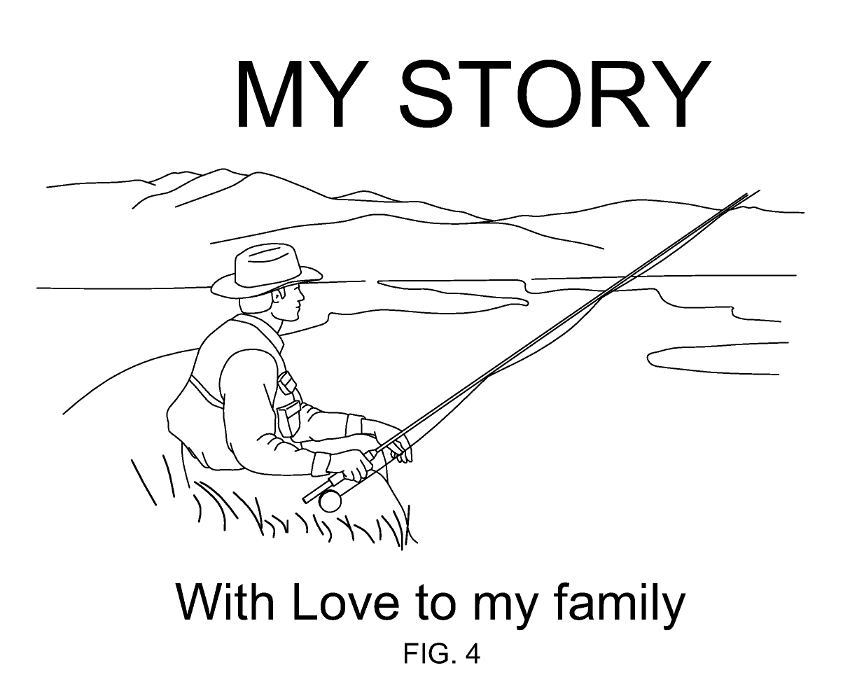

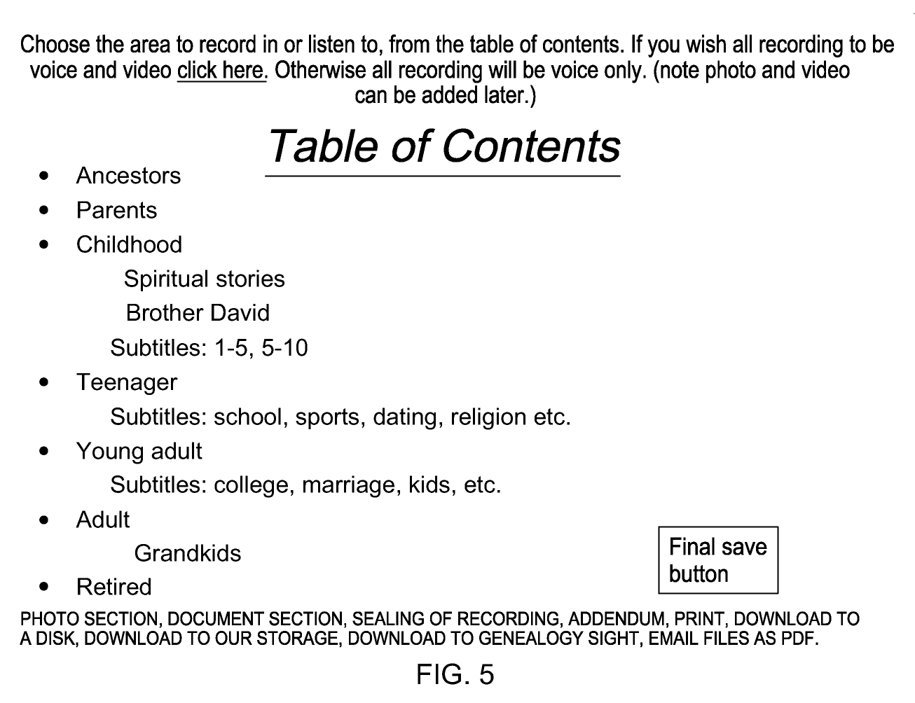

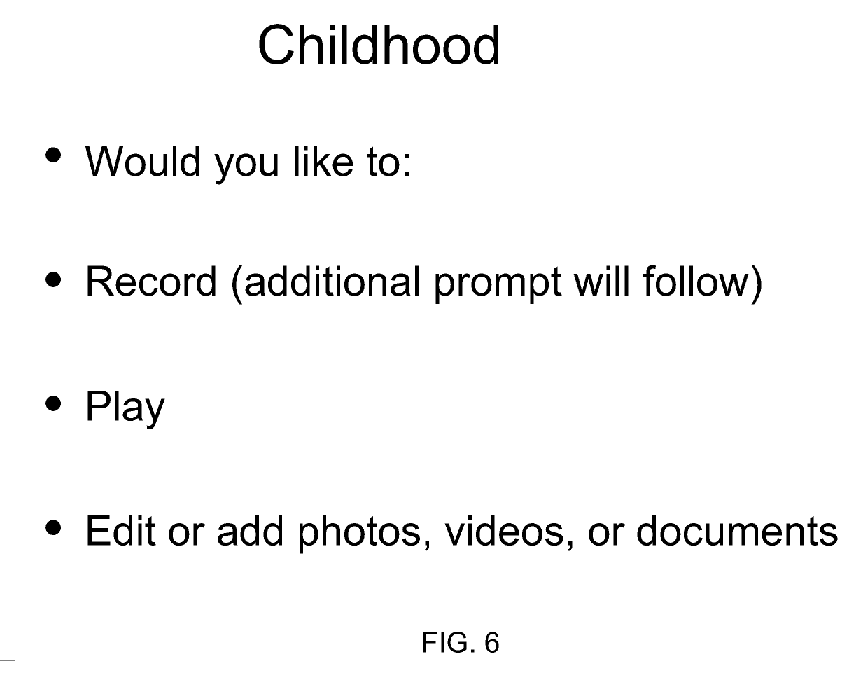

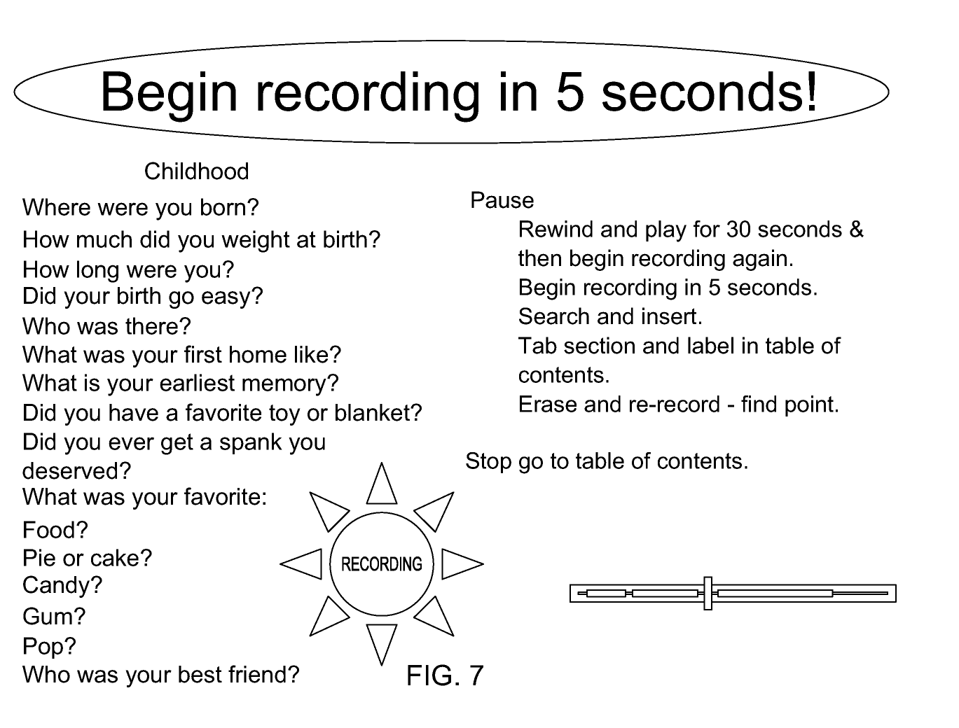

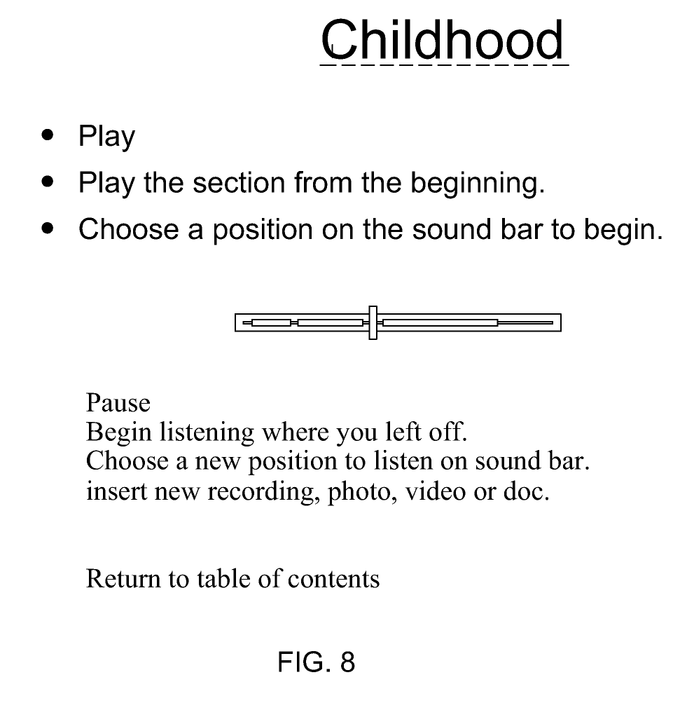

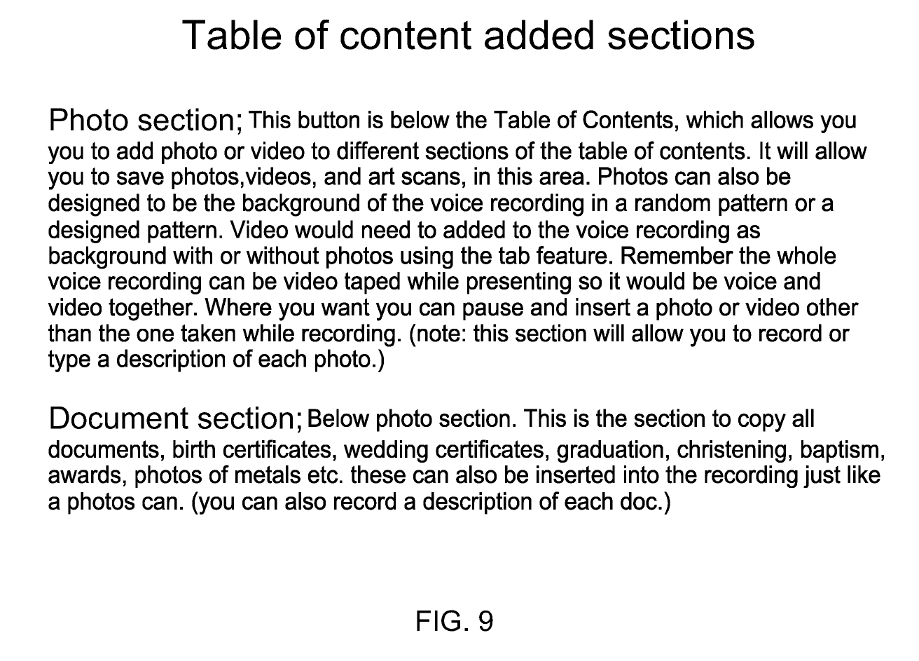

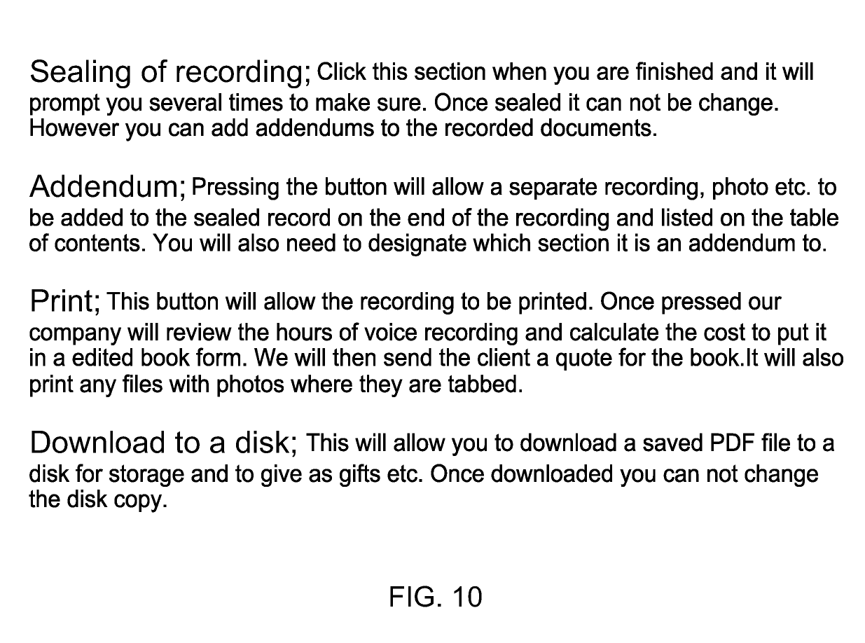

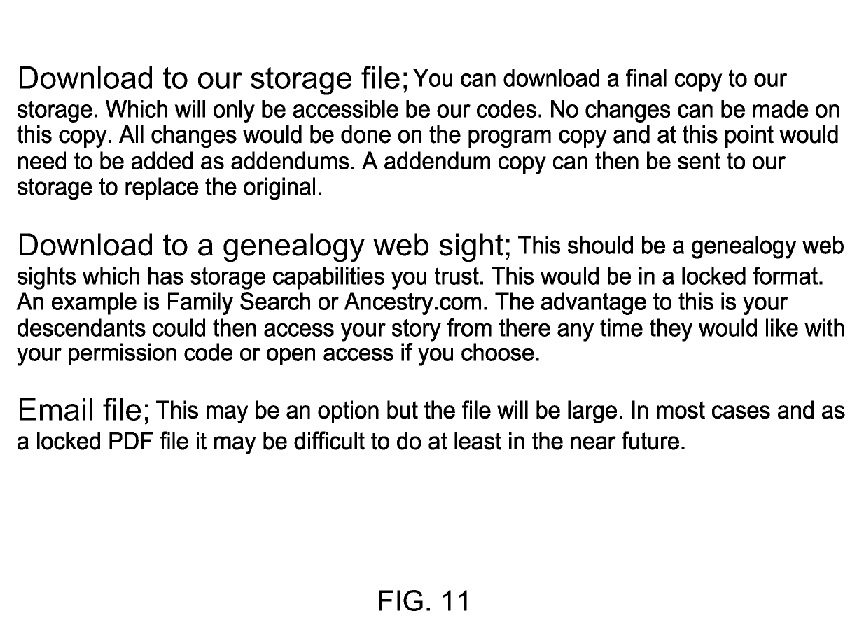

FIGS. 4-11 illustrates prophetic screenshots of a media collection system, according to one embodiment of the invention. One or more of the features, functions, benefits, processes, capabilities, etc. described below and/or illustrated in FIGS. 4-11 may be incorporated into one or more embodiments of the invention as one or more modules, which module(s) would be functionally coupled to other modules described herein as appropriate to perform their function.

According to one embodiment of the invention, the media collection system may include a cover page designed to enable a user to add their own photo, photos, recordings, etc. and a tag line to their story. The cover page may include a security function that needs to be authorized to access the data from a user interface module.

The illustrated Media collection system may include a table of contents designed to control the categorization of the recordings and images and also formats the data to match other data used in the media collection system. The table of contents makes it easy to retrieve by category and/or subcategory. The table of contents allows for easy additions to each category as well as subcategories or new categories.

The illustrated media collection system makes it easy and possible to take a voice recording. The voice recording block includes a section that the user may copy, or separate into a subcategory or category for easy retrieval. This process of voice recording may be essential to the Media collection system.

The illustrated media collection system is designed with a section in the table of contents for adding photos. Each photo may include a voice recording with it explaining who, what and where it was taken. The user may also group them into categories and subcategories such as: childhood, teenage years, and adult years, with subcategories of wedding photos, military photos, birth photos, vacation or trip photos, etc. The same is true with documents and home movies and videos.

The illustrated media collection system includes a table of contents that may include modules and components to:

Print a Copy.

When clicked on, the user interface module may notify the Media collection system and displays a total of the hours of recording, pages of photos and documents. The system may then give the user a response back as to the cost of the printing in book form or publishing thereof.

Download to a Disk.

This will allow the user to download the recording, photos and documents to a disk, (or several disks depending on the size of the file). This format may or may not allow the users to edit or change the information once downloaded. The data may also be emailed.

Sealing of Record.

Clicking on this section may bring up several prompts to make sure the user wants to seal the recording so no one may change it. This option may be especially important if the user feels someone may want to change their story after user is gone.

Addendum.

When this category is pushed it may allow the user to add addendums to the record, which may be sealed. This makes it possible for a wife or child etc. to record a change to a story as they remember it so it is on record as being different then the user remembered when the user recorded your story. This new addendum may be added to the sealed record as an addendum under the table of contents as addendum with a title.

According to one embodiment of the invention, once a category is chosen from the table of contents a new screen opens up.

For example if Childhood is chosen:

A new pages shows the choices of:

Record. (further prompts will follow when clicked.)

Play what has been recorded.

Edit or Insert photos, videos, or documents.

When Record is clicked the following page opens up.

New recording. (prompt will follow.)

Begin recording where you left off. (two buttons are available)
Play 30 seconds then click big button to begin recording.
Begin recording where you left off. (prompt will follow.)
   The recording page will then come up on screen.

This page has several things on it. At the top is a big button which says (Begin recording in 5 seconds!)

Below that is the category you are recording in from the table of contents.

### (Childhood)

Below that and to the left are the prompt questions, which are there to jog your memories. This list is tied to the category from the table of contents. So if you are in Childhood the questions will relate to childhood or if in teenage years they will relate to teenage years.

To the right are two buttons:

Pause.
When clicked on Pause will open up to several options:
Begin recording in 5 seconds.
Play 30 seconds and then click the record in 5 seconds.
Tab section and label in the Table of contents. (instructions to follow when selected.)
Tab section and erase and re-record. (instructions to follow when selected.)
Tab and insert new recording. (instructions to follow when selected.)

Stop.
When pushed it will save, and return to table of contents. The system may automatically save content on a regular bases as well.

Also on this page will be a big star shaped symbol, which appears when recording is going on. At the bottom of the page is the recording bar. It shows where breaks in recording are and allows you to tab back in what you have recorded to insert, erase, label and add photos, video and documents. Also if you are in the play mode it will allow you to pick where in the recording you would like to listen from.

Under the Play Option on the Opening Page of Childhood Etc.:

One button will play from the beginning of the section of the table of contents you have chosen.

The second button will allow you to find a place on the recording bar to begin listening from.

It will also have a pause button and a stop button. As in recording the stop button will save and send you back to the table of contents. The Pause button will give you the option to begin listening from where you stopped, replay 30 seconds and continue to listen, or Pause and edit, insert, erase, label and add photos, video, and documents.

The goal is to make recording your personal history easy and to allow the listener the ability to find things of interest to them with ease through use of the Table of Contents chapters and subchapters.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

As a non-limiting example, one or more of the methods/systems described herein may be accessible on a plurality of computing/electronic devices, including but not limited to smartphones, tablets, personal computers, dumb terminals, second-screen interfaces, e-book readers, and the like and combinations thereof.

As another non-limiting example, one or more of the methods and/or modules described herein may operate to perform functions adapted to one or more functions, such as but not limited to journaling; school reports; recording a personal, company, family, etc. history; storytelling; writing a book/novel; research reporting; journaling lab work/experiments; instruction of groups and/or individuals; and/or any purpose for which breaking up/organizing/managing/publishing/etc. audio segments together with media files may be useful.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A media collection system, comprising:
a) a user interface module operating through a user interface device that allows a user to add media information to a structured media collection, including:
a1) a real-time recording module that allows a user to record media information to a media file in real-time and that includes:
aa1) a countdown synchronization module that displays a real-time countdown to initialization of a recording;
aa2) a prompt module that displays suggested recording topics; and
aa3) a recording control module that allows a user to control the initialization, stop, and file location of recording; and
a2) an organization module that allows a user to associate media files within a hierarchical structure; and
b) a media structure module that enforces and presents stored media files according to their association within the hierarchical structure.

2. The system of claim 1, wherein the media structure module further comprises a template module that provides preset hierarchical structure and prompts.

3. The system of claim 1, wherein the user interface module further comprises a place finder module that allows a user to back-up, seconds and play, then record with countdown.

4. The system of claim 1, wherein the organization module is graphical, drag and drop, connectivity.

5. The system of claim 1, wherein the user interface module further comprises a delay module that allows a user to delay the initialization of a recording.

6. The system of claim 1, wherein the user interface module further comprises an automated marking module that allows a user to automatically mark parts of a recording from a trigger.

7. The system of claim 1, wherein the media structure module further comprises a user account module that allows different permissions for users; wherein other users may add media content but cannot delete media content.

8. The system of claim 1, wherein the user interface module further comprises a voice recognition module that allows voice recognition for a user during recording of media information.

9. The system of claim 1, wherein the media structure module further comprises a publication module that allows a user to publish a structured media collection over a computerized network.

10. A method of providing a media collection system over a computerized network, comprising the steps of:
a) providing a user interface module operating through a user interface device that allows a user to add media information to a structured media collection, including the steps of:
a1) providing a real-time recording module that allows a user to record media information to a media file in real-time and that includes:
aa1) providing a countdown synchronization module that displays a real-time countdown to initialization of a recording;
aa2) providing a prompt module that displays suggested recording topics; and
aa3) providing a recording control module that allows a user to control the initialization, stop, and file location of recording; and
a2) providing an organization module that allows a user to associate media files within a hierarchical structure; and
b) providing a media structure module that enforces and presents stored media files according to their association within the hierarchical structure.

11. The method of claim 10, wherein the step of providing a media structure module further comprises the step of providing a template module that provides preset hierarchical structure and prompts.

12. The method of claim 10, wherein the step of providing a user interface module further comprises the step of providing a place finder module that allows a user to back-up, seconds and play, then record with countdown.

13. The method of claim 10, wherein the step of providing a user interface module further comprises the step of providing a delay module that allows a user to delay the initialization of a recording.

14. The method of claim 10, wherein the step of providing a user interface module further comprises the step of providing an automated marking module that allows a user to automatically mark parts of a recording from a trigger.

15. The method of claim 10, wherein the step of providing a media structure module further comprises the step of providing a user account module that allows different permissions for users; wherein other users may add media content but cannot delete media content.

16. The method of claim 10, wherein the step of providing user interface module further comprises the step of providing a voice recognition module that allows voice recognition for a user during recording of media information.

17. The method of claim 10, wherein the step of providing a media structure module further comprises the step of providing a publication module that allows a user to publish a structured media collection over a computerized network.

18. A media collection system, comprising:
a) a user interface module operating through a user interface device that allows a user to add media information to a structured media collection, including:
a1) a real-time recording module that allows a user to record media information to a media file in real-time and that includes:
aa1) a countdown synchronization module that displays a real-time countdown to initialization of a recording;
aa2) a prompt module that displays suggested recording topics; and
aa3) a recording control module that allows a user to control the initialization, stop, and file location of recording;
a2) an organization module that allows a user to associate media files within a hierarchical structure; wherein the organization module is graphical, drag and drop, connectivity;
a3) a place finder module that allows a user to back-up, seconds and play, then record with countdown;
a4) a delay module that allows a user to delay the initialization of a recording;
a5) an automated marking module that allows a user to automatically mark parts of a recording from a trigger; and
a6) a voice recognition module that allows voice recognition for a user during recording of media information; and
b) a media structure module that enforces and presents stored media files according to their association within the hierarchical structure, including:
b1) a template module that provides preset hierarchical structure and prompts;
b2) a user account module that allows different permissions for users; wherein other users may add media content but cannot delete media content; and
b3) a publication module that allows a user to publish a structured media collection over a computerized network.
